(19) United States
(12) Patent Application Publication
(10) Pub. No.: US 2024/0267794 A1
(43) Pub. Date: Aug. 8, 2024

(54) INTELLIGENT CONTROL FOR CELLULAR RADIO ACCESS NETWORKS

(71) Applicant: The Texas A&M University System, College Station, TX (US)

(72) Inventors: Srinivas G. Shakkottai, Cypress, TX (US); Woo-Hyun Ko, College Station, TX (US); Harish Kumar Dureppagari, Blacksburg, VA (US); Ujwal Dinesha, College Station, TX (US); Venkata Siva Santosh Ganji, Bryan, TX (US); Dinesh Bharadia, San Diego, CA (US); Raini Y. Wu, San Diego, CA (US); Ushasi Ghosh, San Diego, CA (US)

(21) Appl. No.: 18/437,149

(22) Filed: Feb. 8, 2024

Related U.S. Application Data
(60) Provisional application No. 63/444,032, filed on Feb. 8, 2023.

(51) Int. Cl. H04W 28/18; H04L 41/16

(52) U.S. Cl. CPC H04W 28/18; H04L 41/16

(57) ABSTRACT

In some examples, a system includes a communication network having a cloud portion and an edge portion. The communication network comprises a cloud controller, a radio access network (RAN), and an edge computing device. The edge computing device is co-located with at least a portion of the RAN. The edge computing device is configured to, within one transmission time interval (TTI) of the RAN, obtain network state information of the communication network, determine control actions for modifying operational settings of the RAN, and transmit the control actions to the RAN.

### CROSS-REFERENCE TO RELATED APPLICATIONS

This application claims priority to U.S. Provisional Patent Application No. 63/444,032 filed on Feb. 8, 2023 and titled “Intelligent Control for Cellular Radio Access Networks,” which is incorporated herein by reference in its entirety.

### STATEMENT REGARDING FEDERALLY SPONSORED RESEARCH OR DEVELOPMENT

This invention was made with government support under Contract No. CNS 1955696 awarded by the National Science Foundation and under Contract No. W911NF-19-1-0367 awarded by the Army Research Office. The Government has certain rights in the invention.

### REFERENCE TO A MICROFICHE APPENDIX

Not applicable.

### BACKGROUND

A Radio Access Network (RAN) facilitates communication in a wireless cellular network. For example, the RAN transmits wireless signals to, and receives wireless signals from, user devices (e.g., smartphones, cellular hotspots, cellular enabled computers, cellular enabled wearable devices, cellular enabled vehicles, cellular enabled sensors, Internet-of-Things (IoT) devices, or the like). The RAN also communicates with a core network of a telecommunications provider to provide Internet connectivity to the user devices. For example, the RAN aggregates communications received from the user devices and provides those communications to the core network, and receives aggregated communication from the core network for distribution to respective user devices.

### SUMMARY

In some examples, a system includes a communication network having a cloud portion and an edge portion. The communication network comprises a cloud controller, a radio access network (RAN), and an edge computing device. The edge computing device is co-located with at least a portion of the RAN. The edge computing device is configured to, within one transmission time interval (TTI) of the RAN, obtain network state information of the communication network, determine control actions for modifying operational settings of the RAN, and transmit the control actions to the RAN.

In some examples, an edge computing device is configured to obtain, from a RAN, network state information of a communication network, receive a machine learning policy from a cloud computing device, apply the machine learning policy to the network state information to determine control actions for modifying operational settings of the RAN to provide communication service to a user equipment in the communication network via the RAN, and transmit the control actions to the RAN.

In some examples, an emulated edge computing device is configured to implement, in an emulated network environment configured to emulate a communication network, a machine learning policy for control of operational characteristics of an emulated RAN, receive network state information of the emulated network environment, apply the machine learning policy to the network state information to determine control actions for modifying operational settings of the emulated RAN, transmit the control actions to the emulated RAN, receive a reward associated with operation of the emulated RAN according to the control actions, the reward determined according to a machine learning reward function, and train the machine learning policy according to the reward.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a block diagram of a communication system, in accordance with various examples.

FIG. 2 is a diagram of communication events in a communication system, in accordance with various examples.

FIG. 3 is a flowchart of a method, in accordance with various examples.

FIG. 4 is a block diagram of an emulation environment, in accordance with various examples.

FIG. 5 is a flowchart of a method, in accordance with various examples.

FIG. 6 is a block diagram of a computer system, in accordance with various examples.

### DETAILED DESCRIPTION

It should be understood at the outset that although illustrative implementations of one or more examples are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

As described above, a Radio Access Network (RAN) facilitates communication in a wireless cellular network, such as between user devices and a core network, which further provides connectivity for the user devices to a wide area network (WAN), such as the Internet, a private WAN, or the like. To optimize or otherwise improve performance of the RAN, the RAN may be provided with a RAN Intelligent Controller (RIC). A RIC may access both application layer data and RAN-level data, enabling cross-layer decision making and control of the RAN. A RIC may operate in non-realtime, such as at timescales of 1 second or greater. Such a non-realtime RIC may be implemented, for example, at the core network or as a cloud service that communicates with the RAN. Actions performed by a non-realtime RIC may include, for example, RAN management, offline training, or the like. A RIC may also, or alternatively, operate in near-realtime, such as at timescales of about 10 milliseconds (ms) to about 1 second. Such a near-realtime RIC may be implemented, for example, at the core network or as a cloud service that communicates with the RAN. Actions performed by a near-realtime RIC may include, for example, user device or user equipment (UE) load balancing, RAN configuration, and the like.

However, conditions in wireless network may change rapidly. For example, in a millisecond, or sub-millisecond, timescale. Thus, the non-realtime and near-realtime RICs described above may not be suitable for control of a RAN for certain application environments. Some of these application environments may include moving vehicles (manually controller, semi/partially autonomous, or fully autonomous), such as airborne vehicles (manner or unmanned), trains, buses, trucks, automobiles, robots, industrial machines, or the like, safety/security devices, augmented/virtual reality devices, or the like in which low latency, high throughput, or other operational requirements may be necessary.

Examples of this description provide for a realtime RIC. To provide a realtime RIC which may be suitable for at least some of the application environments described above, such as a RIC that that operates in a microsecond (μs) timescale, the RIC may be located physically and communicatively near to the RAN. For example, the RIC may be implemented at a base station in a telecommunication network, at (e.g., physically and/or communicatively near) a Distributed Unit of the RAN, such as an O-DU, in an edge device of the communication network that communicates with the RAN without routing those communications through the core network, or the like. By locating the realtime RIC physically and/or communicatively close to the RAN, metrics obtained by the realtime RIC related to the RAN may be more current and relevant in comparison to the metrics when received by the near-realtime RIC or non-realtime RIC, which may be physically and/or communicatively distant from the RAN. As a result, such a realtime RIC may in some application environments, be capable of operating in a timescale of less than about 1 ms, such as less than or equal to about 100 μs. Actions performed by a realtime RIC may include, for example, measurement, optimization, and/or control of RAN resources corresponding to a cellular transmission time interval (TTI) (e.g., about 125 μs to about 1 ms), which may be the smallest unit of decision-making time available at the RAN, or any other suitable time interval. In some examples, operation of the realtime RIC is decoupled from the RAN such that, in an event that the realtime RIC misses its time target, the RAN may continue to operate without added delay or latency resulting from the miss by the realtime RIC. Similarly, the realtime RIC being decoupled from the RAN may facilitate interoperability among multiple RAN infrastructure types of hardware vendors (e.g., RAN agnostic), contrasted to approaches which may be integrated into the RAN itself and therefore vendor or infrastructure specific.

In some examples, the realtime RIC implements machine learning or other artificial intelligence processing to perform the realtime control of the RAN. For example, via reinforcement learning (RL), policies may be formed by which the realtime RIC operates. The reinforcement learning may be performed, in various examples, via the non-realtime or near-realtime RIC to determine a RL policy, and the RL policy may be provided to the realtime RIC for implementation by the realtime RIC. In various examples, the reinforcement learning may be performed based at least in part on information captured, measured, or received by the realtime RIC and provided by the realtime RIC to the non-realtime RIC and/or the near-realtime RIC. In some examples, the reinforcement learning may additionally, or alternatively, be performed based at least in part on information captured, measured, or otherwise provided by RAN to the non-realtime RIC and/or the near-realtime RIC. In some examples, the realtime RIC implements the RL policy or policies via one or more micro applications (μApps). Via the μApps, the realtime RIC may control the RAN to provide resource allocation to UEs according to the RL policy or policies, increasing a user experience of users of the UEs. For example, the μApps may provide weights to the RAN, derived from the RL policy or policies. The weights may instruct or otherwise control resource allocation of the RAN to provide a greater level of resource allocation to UEs granted greater value weights, and a lesser level of resource allocation to UEs granted lower value weights. In other examples, via the μApps, the realtime RIC may modify or otherwise control operation of any suitable characteristic(s) of the RAN which are configurable or modifiable, the scope of which is not limited herein. Some examples of such characteristics include a modulation scheme by which the RAN communicates with a UE, wireless channel estimation using rule-based or ML-aided methods, analog beam steering or digital beam forming to choose the directionality of communication, transmission power control for efficient RAN operations, spectrum resource allocation across multiple RAN sites, or the like.

The RL policies, μApps, or both may be application aware. For example, the realtime RIC may receive application-specific information from the UEs, the RAN, or both. The application-specific information may include, for example, buffer status of a streaming application, viewing angle(s) of an augmented or virtual reality application, positional data of robotic controllers, data freshness of industrial devices, or the like. This application-specific information may enable tuning of adjustment of the RL policies such that a particular application operating on a UE, and the operating characteristics of that application, may be considered in the RL policies and resource allocation by the RAN. For example, in a video streaming application environment, rather than merely attempting to maximize throughput, it might be useful to prioritize users nearing buffer exhaustion to prevent video playback halt. Thus, such an application-aware resource allocation may improve a user experience of users of the UEs, and/or performance of the UEs, in comparison to application-agnostic resource allocations.

In some examples, to perform the reinforcement learning, the cellular network may be emulated in a digital environment. This may be referred to as a “digital twin” of the cellular network. The digital twin may be formed by collecting channel data of the cellular network for various environments and simulating operating of the cellular network given that channel data for various setting configurations of the RAN. In an example, the digital twin may be used by a machine learning process to perform the reinforcement learning described above, resulting in a RL policy. The RL policy may then be provided from the digital twin to the realtime RIC for implementation in the cellular network. To perform the reinforcement learning, as well as to make decisions based on the resulting RL policy and current network conditions, various characteristics of the RAN (e.g., a RAN state) may be considered. Such characteristics may include, Radio Network Temporary Identifiers (RNTIs) for UE identities, per-UE backlog buffer states, per-UE channel quality (such as may be indicated by Channel Quality Indicators (CQIs)), previous downlink transmit bitrates, inter-service times for each UE, block error rates, processed information such as the level of violation of a prescribed service level agreement (throughput, jitter, reliability etc.), or any other suitable measurable or reportable characteristics.

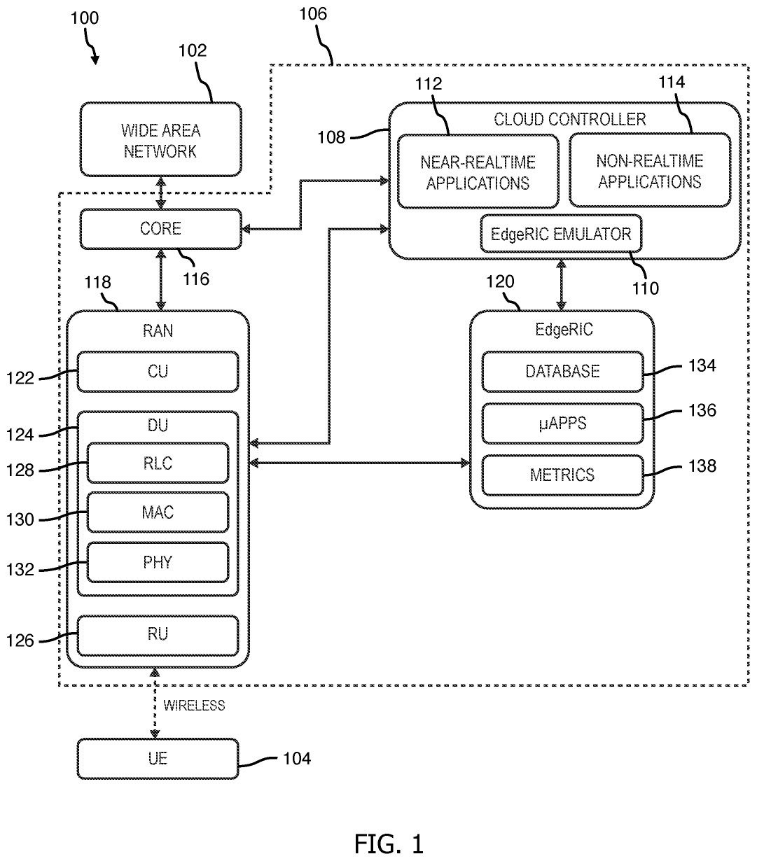

FIG. 1 is a block diagram of a communication system 100, in accordance with various examples. The communication system 100 may be generally representative of a wireless communication system, such as a cellular communication system, in which wireless communication is facilitated between a WAN 102 and a UE 104 by a network 106. In an example, the WAN 102 is any suitable network, such as the Internet, a private WAN or network, a cloud computing environment, or the like. In some examples, one or more application servers (not shown) are hosted provided by the WAN 102 (e.g., hosed in, or by, the WAN 102). The UE 104 may be any suitable device, the scope of which is not limited herein, such as a smartphone, cellular hotspot, cellular enabled computer, cellular enabled wearable device, cellular enabled vehicle, cellular enabled sensor, Internet-of-Things (IoT) device, or the like. In an example, the network 106 facilitates communication according to any suitable standard, protocol, or format, the scope of which is not limited herein. In some examples, the network 106 facilitates communication via 5G technologies and standards, while in other examples the network 106 facilitates communication via any other suitable predecessor or successor technology to 5G which may share one or more commonalities with 5G.

In an example, the network 106 includes a cloud controller 108, including an EdgeRIC emulator 110, near-realtime applications 112, and non-realtime applications 114. In an example, the near-realtime applications 112 may perform various operations in the network 106, such as UE load balancing, coarse scale or macro RAN configuration, and the like. In an example, the non-realtime applications 114 may perform various operations in the network 106, such as coarse scale or macro RAN management, offline training, or the like.

The network 106 also includes a core 116, a RAN 118, and an EdgeRIC 120, which may be a realtime RIC, as described above herein. The core 116 may be any suitable core network of a telecommunication or other service provider which facilitates communication between the Wan 102 and the UE 104, providing of services to the UE 104, authentication of the UE 104 in the network 106, or any other suitable functions, the scope of which is not limited herein. In some examples, the RAN 118 and the EdgeRIC 120 are co-located, physically and/or communicatively, such that communication latency between the RAN 118 and the EdgeRIC 120 is less than communication latency between the RAN 118 and the cloud controller 108. The RAN 118 may include any suitable components for providing communication connectivity between the WAN 102 and the UE 104, the scope of which is not limited herein. In at least some examples, the RAN 118 includes, or implements, a Central Unit (CU) 122, a Distributed Unit (DU) 124, and a radio unit (RU) 126. In some examples, the DU includes, or implements, a radio link controller (RLC) 128, a media access controller (MAC) 130, and a physical layer (controller PHY) 132. In some examples, the RAN 118 and the EdgeRIC 120 may be at least partially implemented by a same computing device. For example, a server may implement at least some portions of the RAN, such as the DU 124, as well as the EdgeRIC 120. For example, first computing resources of the server may implement the DU 124 and second computing resources of the server may implement the EdgeRIC 120.

In an example, the EdgeRIC 120 includes a database 134, μApps 136, and a metrics monitoring system 138. The EdgeRIC 120 may include an interface (not shown) to facilitate communication with other devices, such as the RAN 118, including the DU 124 or its sub-components according to a particular communication standard or communication procedure to provide communication to the RAN 118 in a format interpretable by the RAN 118. The RAN 118 may include a counterpart interface to facilitate communication between the RAN 118 and the EdgeRIC 120. In an example, the EdgeRIC 120 communicates with the RAN 118 via an E2 application protocol (E2AP) interface. In some examples, the RAN 118 may also communicate with the cloud controller 108, such as with the near-realtime applications 112, via another E2AP interface, which may vary in operation from the E2AP interface through which the RAN 118 and the EdgeRIC 120 communicate. For example, the RAN 118 and the EdgeRIC 120 may communicate according to a periodic publish-subscribe procedure in which the RAN 118 (e.g., the DU 124 or a sub-component of the DU 124, such as the RLC 128) publishes information at a programmed periodicity. In some examples, the programmed periodicity is one TTI. One or more of the μApps 136 may subscribe to the information published by the RAN 118, such as for performing interference and control of the RAN. In some examples, the subscription may be blocking such that a μApp 136 will only proceed with a given control operation responsive to new information being available from the RAN 118 via the subscription. In some examples, the information published by the RAN 118 includes state information of the RAN 118, such as for enabling the μApps 136 to determine current operational conditions of the RAN 118 and/or the UE 104. In some examples, the information published by the RAN 118 includes application state information received from the UE 104. For example, in a video or audio (e.g., media) streaming application environment, the application state information may indicate a buffer state of a media streaming application of the UE 104. Other examples of application state information may include head-pose and eye-tracking information for extended (e.g., augmented or virtual) reality applications, staleness of sensor values in sensing and estimation applications, environment conditions, pose, and nearness to obstacles in autonomous ground and air vehicle applications, or the like. In at least some examples, the EdgeRIC 120 obtains metrics, network state information, or other characteristics or measurements from the RAN 118 via the metrics monitoring system 138.

In some examples, one or more of the μApps 136 may publish information at a programmed periodicity. In some examples, the programmed periodicity is again one TTI. One or more components of the RAN 118 may subscribe to the information published by a μApp 136, such as to enable control of the RAN 118 based on instructions of the μApp 136. In some examples, the subscription may be non-blocking such that the RAN 118 will move on, continuing with programmed operation if no new information is received from a μApp 136 within one TTI. In some examples, the information published by the μApps 136 includes control information for controlling operation of the RAN 118. The control information may include weights or other priorities for performing resource allocation to UE devices, including the UE 104, instructions for controlling modulation schemes, or the like.

To facilitate interconnection and communication between the RAN 118 and the EdgeRIC 120 via the E2AP interface, application programming interfaces (APIs) may be provided. The APIs may facilitate communication via a message-passing layer existing between the RAN 118 and the EdgeRIC 120. In some examples, the message-passing layer is implemented via ZeroMQ, which may provide low-latency and low-overhead communication.

In some examples, communication between the RAN 118 and the EdgeRIC 120 may be synchronized to a TTI clock of the RAN 118. For example, a first counter (RANtime) may be maintained at the RAN 118 and a second counter (RICtime) may be maintained at the EdgeRIC 120. At the beginning of each TTI, the RAN 118 may publish the RANtime. The EdgeRIC 120 receives the RANtime and compares the RANtime to the RICtime. Responsive to the EdgeRIC 120 determining that RANtime<RICtime, the EdgeRIC 120 may pause execution, such as execution of the μApps 136, until subsequently determining that determining that RANtime=RICtime. Similarly, responsive to the EdgeRIC 120 determining that RANtime>RICtime, the EdgeRIC 120 may reset RICtime to be equal to RANtime. In this way, synchronization between the RAN 118 and the EdgeRIC 120 may be maintained at each TTI.

In some examples, the EdgeRIC 120 stores data received from the RAN 118 in the database 134, such as for subsequent transmission to the cloud controller 108, use by a μApp 136, or any other suitable purpose. In some examples, the database 134 may be implemented as a Remote Dictionary Server (Redis) database.

In some examples, the μApps 136 execute one or more RL policies. The RL policies may be stored in the database 134. In some examples, the RL policies are received from the cloud controller 108. For example, the EdgeRIC emulator 110 may emulate a communication network which may be substantially similar to the network 106. Based on that emulated network, the EdgeRIC emulator 110 may generate the RL policies via machine learning processing. For example, the EdgeRIC emulator 110 may implement reinforcement learning, a subset of machine learning, to generate the RL policies based on simulated operations performed in the emulated network environment. The RL policies may specify, responsive to particular network characteristics in the network 106, rules for operation of the RAN 118 (e.g., such as rules for resource allocation, modulation schemes, or the like). The EdgeRIC emulator 110 may provide the RL policies to the EdgeRIC 120 for implementation in the network 106. At least some of the μApps 136 may be substantially realtime applications (in contrast to the near-realtime applications 112 and non-realtime applications 114), operating at a timescale of 1 ms or less. Because of the substantially realtime capability of the μApps 136, at least some of the μApps 136 may perform fine scale, or micro, RAN configuration, such as by providing instructions to the RLC 128, a MAC 130, and/or PHY 132 to control operation of the RLC 128, a MAC 130, and/or PHY 132, respectively, within one TTI of the RAN 118. As a result, the EdgeRIC 120, via the μApps 136, may enable configuration and optimization of operation of the RAN 118 in latency-sensitive application environments in a manner which may be unavailable from the near-realtime applications 112 and non-realtime applications 114.

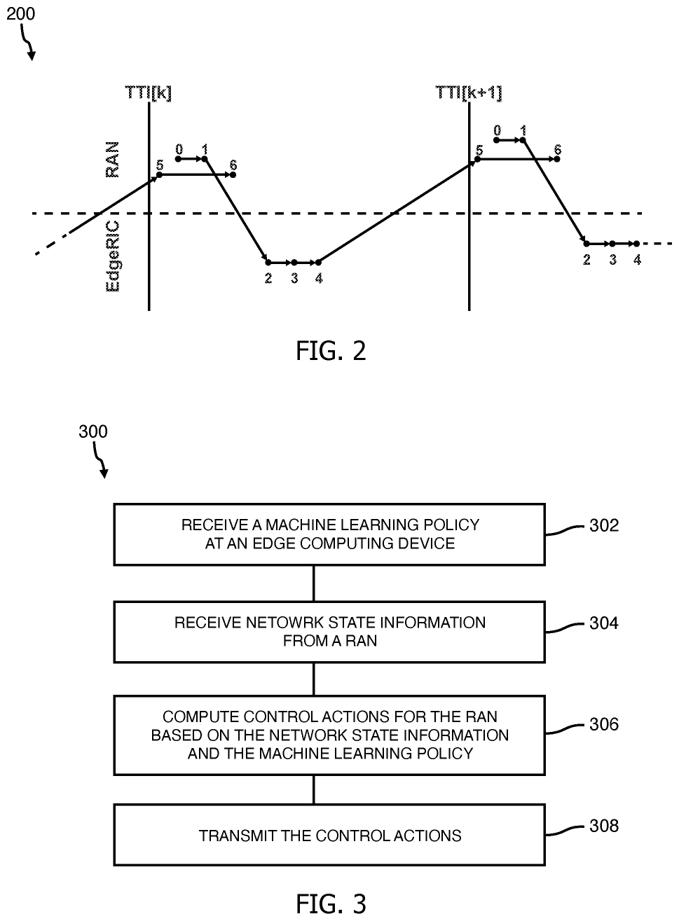

FIG. 2 is a diagram 200 of communication events in a communication system, in accordance with various examples. In an example, the diagram 200 shows events which occur within one TTI (e.g., TTI-level events) in the communication system 100. Six discrete events are shown in the diagram 200, spread across the RAN 118 and the EdgeRIC 120, for a k^{th} TTI (e.g., TTI[k]). It should be noted that the diagram 200 is a conceptual diagram showing ideal performance of communication events occurring between the RAN 118 and the EdgeRIC 120, and in application timings may be different as a result of communication latency, processing delay, or other factors that may vary in physical implementation. In addition, other communication events not shown in the diagram 200 may occur between the RAN 118 and the EdgeRIC 120, such as the RAN 118 publishing the RANtime, as described above. The diagram 200 is described below in chronological order. However, it should be noted that the numbering of times in the diagram 200 reset and increment for a single cycle of operation. Thus, a first cycle of operation may continue and finish while a second cycle of operation is beginning, resulting in a chronological order of operations of the RAN 118 and EdgeRIC 120 that results in described times being out of numerical order.

At time 5, the RAN 118 receives an action from the EdgeRIC 120. In some examples, the EdgeRIC 120 determines the action via one or more of the μApps 136 according to a RL policy, which may be received from the cloud controller 108. The EdgeRIC 120 may determine the action by applying the RL policy to state information received from the RAN 118, which may include information related to current operational characteristics of the network 106, application state information of an application of the UE 104, or the like. In some examples, the action includes instructions for weighting the allocation of resources to UEs, including the UE 104, in communication with the RAN 118, such as based on relative priorities of the UEs as determined according to the RL policies. In some examples, such as examples in which the EdgeRIC 120 has experienced a processing delay, the RAN 118 may not receive an action from the EdgeRIC 120 at time 5.

At time 0, the RAN 118 measures, or otherwise obtains, state information. The state information may include information related to current operational characteristics of the network 106, application state information of an application of the UE 104, or the like. In some examples, the RAN 118 measures the state information based on performance of one or more components of the RAN 118, such as the DU 124, including any one or more of the RLC 128, MAC 130, or PHY 132, or the RU 126. In other examples, the RAN 118 may receive at least some of the state information from sensors which may be deployed in a geographic area proximate to the RU 126 and which communicate with the RU 126, such as to report network conditions at particular locations to the RAN 118. In yet other examples, the RAN 118 obtains at least some of the state information from the UE 104 in the form of application state information.

At time 1, the RAN 118 transmits the state information. In some examples, the RAN 118 transmits the state information by publishing the state information via the E2AP interface, as described above herein.

At time 6, the RAN 118 implements the action received from the EdgeRIC 120 at time 5. In various examples, implementing the action may take various forms. For example, implementing the action may include performing an allocation of resources (e.g., resource block groups) among UEs in an amount proportional to weights received from the EdgeRIC 120. In another example, implementing the action may include communicating with various UEs according to respective modulation schemes specified by the EdgeRIC 120. In other examples, implementing the action may include modifying any one or more controllable or configurable operational settings of the RAN 118 based on instructions, weights, values, or other data received from the EdgeRIC 120. In examples in which the RAN 118 does not receive the action from the EdgeRIC 120 at time 5, or prior to time 6 after the beginning of TTI[k], the RAN 118 may operate according to last used operational settings, default operational settings, a preprogrammed set of operational settings for use in the event of no action being received from the EdgeRIC 120, or according to any other suitable scheme that facilitates non-blocking operation of the RAN 118 such that the RAN 118 will move on, continuing with operation if no new information is received from the EdgeRIC 120.

At time 2, the EdgeRIC 120 receives the state information from the RAN 118 that was measured at time 0 and transmitted at time 1. In some examples, the EdgeRIC 120 receives the state information via a subscription for information from the RAN 118 through the E2AP interface, as described above herein. In some examples, the subscription for information from the RAN 118 may be blocking such that the EdgeRIC 120 will only proceed (e.g., perform computations of control actions) responsive to new information being available from the RAN 118 via the subscription.

At time 3, the EdgeRIC 120 computes an action to be taken by the RAN 118. For example, the EdgeRIC 120 computes the action based on, and responsive to receipt of, the state information from the RAN 118 at time 2. In various examples, computing the action includes applying a RL policy to the state information. The RL policy may be applied to the state information via at least one μApp 136, for example. In an example in which the action includes weights for performing resource allocation, the RL policy may implement any suitable allocation scheme, such as CQI-fair allocation in which the weight for a respective UE is equal to its realized CQI, proportionally fair allocation in which the weight for a responsive UE is equal to a ratio between its current CQI and its average CQI, max-weight allocation in which the weight of a respective UE is equal to a product of its current CQI and the backlogged bytes remaining in a downlink queue of the RAN 118 corresponding to that UE, or any other suitable allocation scheme. In another example in which the action includes weights for performing resource allocation, the RL policy may implement any of the above allocation schemes augmented by application state information, such as a length of a media buffer of a media application of the UE, a length of media remaining in the media buffer of the media application of the UE, or the like. For example, the EdgeRIC 120 may implement an application-aware max-weight allocation in which the weight of a respective UE is equal to a product of its current CQI, the backlogged bytes remaining in a downlink queue of the RAN 118 corresponding to that UE, and the length (either total length, used length, or available length) of the media buffer of the UE. In some examples, the weight may be normalized subsequent to its computation. In examples in which the EdgeRIC 120 did not receive state information from the RAN 118 at time 2, any computational operations at time 3 may be blocked or omitted such that they are not performed.

At time 4, the EdgeRIC 120 transmits the action computer at time 3. In some examples, the EdgeRIC 120 transmits the state information by publishing the action via the E2AP interface, as described above herein. The action transmitted by the EdgeRIC 120 at time 4 in TTI[k] may be received by the RAN 118 at time 5 in a subsequent TTI (e.g., TTI[k+1]) and implemented by the RAN 118 at time 6 in TTI[k+1], as described above. In examples in which the EdgeRIC 120 did not receive state information from the RAN 118 at time 2, no transmission may occur at time 4

FIG. 3 is a flowchart of a method 300, in accordance with various examples. In an example, the method 300 is implemented by an edge computing device, such as the EdgeRIC 120, in a communication system, such as the communication system 100. The method 300 may be implemented to perform realtime (e.g., <1 ms latency) control of operational settings of a RAN, such as the RAN 118, operating in the communication system. In some examples, the realtime functionality of the method 300 is at least partially enabled by co-locating the edge computing device with the RAN, such as at a same cellular base station, in a same data center, in a same server as implements at least a portion of the RAN, or the like. However, the edge computing device and the RAN may have at least some separate compute resources (e.g., central processing units (CPUs)) to prevent operations performed by one of the edge computing device or the RAN from delaying the other of the edge computing device or the RAN from performing operations.

At operation 302, a machine learning policy is received by the edge computing device. In some examples, the machine learning policy is a RL policy. In other examples, the machine learning policy is computed, generated, or formed according to any other suitable machine learning or artificial intelligence process or processes, the scope of which is not limited herein. In some examples, the edge computing device stores the machine learning policy responsive to its receipt, such as for later recall and execution or implementation by a service or application, such as a μApp 136. In some examples, the edge computing device receives the machine learning policy from another device, such as the cloud controller 108 which executes or implements the EdgeRIC emulator 110 to determine the machine learning policy based on information received by the cloud controller 108 from the RAN 118 and/or data simulated by the EdgeRIC emulator 110. In other examples, the edge computing device itself implements the EdgeRIC emulator 110 such that the edge computing device receiving the machine learning policy includes the edge computing device computing, generating, or otherwise forming the machine learning policy in a manner substantially similar to that described herein with respect to the EdgeRIC emulator 110.

At operation 304, network state information is received from a RAN. In some examples, the network state information is received by the edge computing device from the RAN. In some examples, the edge computing device receives the network state information from the RAN via an E2AP interface in a publish-subscribe format, as described above herein. In some examples, the network state information includes both wireless state information (e.g., CQI) and RAN state information (e.g., backlogged bytes remaining in a downlink queue of the RAN for respective UEs). In other examples, the network state information also includes application state information for one or more UEs, such as a status of media streaming buffers of the UEs.

At operation 306, the edge computing device computes control actions for the RAN based on the network state information and the machine learning policy. In some examples, the control actions include weights for performing resource allocation of resources of the RAN to UEs. For example, the control actions may instruct or otherwise control the RAN to provide a greater level of resource allocation to UEs granted greater value weights, and a lesser level of resource allocation to UEs granted lower value weights. The machine learning policy may determine the weights according to any suitable weighting scheme, as described above. In other examples, the control actions computed by the edge computing device via the machine learning policy and network state information instruct the RAN to modify any one or more operational settings of the RAN, the scope of which is not limited herein.

At operation 308, the control action(s) are transmitted by the edge computing device. In some examples, the control actions are transmitted by the edge computing device to the RAN. For example, the edge computing device may transmit the control actions to the RAN via the E2AP interface in a publish-subscribe format, as described above herein. In some examples, transmitting the control actions to the RAN causes the RAN to allocate wireless network resource blocks to UEs in amounts specified by the control actions. In other examples, transmitting the control actions to the RAN causes the RAN to modulate wireless signals according to a modulation scheme specified by the control actions. In yet other examples, transmitting the control actions to the RAN causes the RAN to modify any one or more operational settings of the RAN, the scope of which is not limited herein.

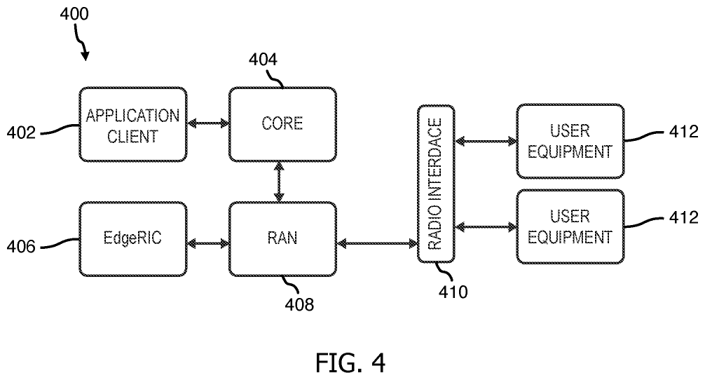

FIG. 4 is a block diagram of an emulation environment 400, in accordance with various examples. In some examples, the emulation environment 400 is implemented by the EdgeRIC emulator 110, as described above herein. The emulation environment 400 may be implemented to emulate a network, such as the network 106. In some examples, the emulation environment is implemented to perform machine learning training, such as by emulating, or simulating, various operational conditions in a network.

In an example, the emulation environment 400 includes an application client 402, a core network 404, an EdgeRIC 406, a RAN 408, a radio interface 410, a UE 412, and a UE 414. The core network 404, the EdgeRIC 406, the RAN 408, and the radio interface 410 may each be emulated, or simulated, virtual devices that facilitate testing in a virtual environment. The virtual devices may be implemented on one or more computer systems, the scope of which is not limited herein. The virtual devices may be formed or instantiated according to any suitable process, such as for creating a “digital twin” implementation, capable of creating a virtual replica of the network 106. In some examples, the radio interface 410 may simulate communication channels to emulate wireless performance (e.g. form synthetic channels). In other examples, the emulation environment 400 may receive network performance characteristics from the RAN 118 and/or the EdgeRIC 120, such as CQIs (e.g., form trace-based channels). In such examples, the radio interface 410 may simulate the wireless communication channels based on the received CQIs, replicating, or simulating, actual measure wireless communications channels of the network 106.

In an example, a UE 412 provides a request to the application client 402. In some examples, the EdgeRIC 406 and the RAN 108 may be implemented substantially according to codebases by which the RAN 118 and the EdgeRIC 120 are implemented, thereby enabling the EdgeRIC 406 and the RAN 108 to more accurately replicate performance of the RAN 118 and the EdgeRIC 120. In some examples, the application client 402 and the UEs 412 may each operation in private Internet Protocol (IP) namespaces, enabling end-to-end operation of real-world applications using TCP or UDP sockets in the emulation environment 400.

In an example, the EdgeRIC 406 implements one or more μApps (not shown) to perform ML training, generate a ML (such as RL) policy, and/or apply a ML policy in the emulation environment 400. For example, a μApp of the EdgeRIC 406 may perform ML training based on any suitable training process or algorithm, such as Proximal Policy Optimization. Generally, the training may be performed according to any suitable ML learning or training process for forming a ML policy based on a dataset, the scope of which is not limited herein. For example, an iteration of training performed by the EdgeRIC 408 include collecting samples from the emulation environment 400, adjustment of the EdgeRIC 408′s ML policy neural network weights through backpropagation, and utilization of the updated agent to generate additional samples to assess its performance. A sample, as used in the emulation environment 400, may include one TTI in the network 106 and includes the current state (network state information) of the emulation environment 400, an action taken by the EdgeRIC 408 according to the ML policy in this state, and the reward and next state observed as a result of this action. ML policies may be trained in the emulation environment for various use cases, the scope of which is not limited herein, including at least a throughput-maximization user case and a video streaming stall minimization use case, as described elsewhere herein.

In an example, a ML policy resulting from training in the emulation environment 400 may be provided by the EdgeRIC emulator 110 to the EdgeRIC 120 for implementation in the network 120. The ML policy may subsequently be refined or tune by the EdgeRIC 120 based on network state information received from the RAN 118, or by the EdgeRIC emulator 110 based on network state information received form the RAN 118 and/or the EdgeRIC 120.

While this disclosure generally refers to machine learning in the context of reinforcement learning, other machine learning processes may also be useful in addition, or in the alternative to, reinforcement learning. Other examples of suitable machine learning processes that may be useful are generative or predictive tasks, such as using transformers, language models, classification tasks, such as anomaly detection, or the like.

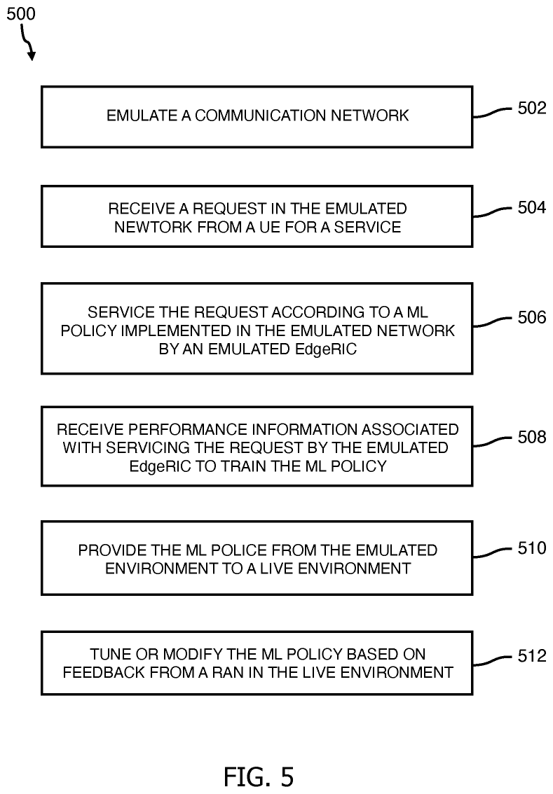

FIG. 5 is a flowchart of a method 500, in accordance with various examples. In an example, the method 500 may be implemented in an at least partially emulated or virtual environment, such as the emulated environment 400. The method 500 may be implemented to emulate, or simulate, performance of a communication network, such as the network 106. In some examples, the communication network may be emulated to enable training, according to the method 500, of a machine learning policy for use in the network 106.

At operation 502, a communication network is emulated. In some examples, emulating the communication network includes creating virtual or digital twins of components of the communication network, such as a core, a RAN, a radio interface, an EdgeRIC, or the like. In some examples, at least some digital twins in the emulated network may be instantiated or formed based on a same codebase as components in the communication network. For example, at least the core and the RAN may be instantiated or formed based on a same codebase as components in the communication network. In some examples, the radio interface simulates wireless communication channels in the communication network based on synthetic channels. In other examples, the radio interface simulates wireless communication channels in the communication network in a trace-based manner based on measured channel or other network characteristics obtained from the communication network.

At operation 504, a request is received in the emulated network from a UE for a service. In some examples, the request is for streaming media from an application client. In other examples, the request is for any other suitable data to be delivered to, or obtained from, any other suitable location.

At operation 506, the request is serviced according to a ML policy implemented in the emulated network by the emulated EdgeRIC. In some examples, the ML policy controls resource allocation, or the setting of other operational parameters or settings of the emulated RAN, in servicing the request.

At operation 508, performance information associated with servicing the request is received by the emulated EdgeRIC to train the ML policy. In some examples, the performance information includes reward information associated with servicing the request, such as determined according to a reward function. Training of the ML policy based on the reward function may be performed according to any suitable machine learning processes, the scope of which is not limited herein. In an example, operations 504 through 508 may be repeated iteratively until the ML policy reaches a programmed threshold state (e.g., the reward reaches a programmed threshold, the reward saturates, or the like), until performance in one TTI reaches a threshold level, until average performance across multiple TTIs reaches a threshold level, or any other suitable indicia of sufficiency of training of the ML policy.

At operation 510, the ML policy is provided from the emulated environment to a live environment. In some examples, providing the ML policy to the live environment includes transmitting the ML policy from the EdgeRIC emulator 110 to the EdgeRIC 120, such as for storage in the database 134 and subsequent application by a μApp 136 to network state information received from the RAN 118. In an example, the ML policy provided to the EdgeRIC 120 at operation 510 may be the machine learning policy received by the EdgeRIC 120 at operation 302, described above with respect to FIG. 3, such that the method 500 and the method 300 may be combinable in the communication system 100.

At operation 512, the ML policy is tuned or modified based on feedback from the RAN 118. In some examples, the ML policy is tuned or modified by the EdgeRIC 120. In other examples, the RAN 118, the EdgeRIC 120, or both provide feedback to the EdgeRIC emulator 110, the EdgeRIC emulator 110 tunes or modifies the ML policy, and provides the tuned ML policy to the EdgeRIC 120 as described above at operation 510.

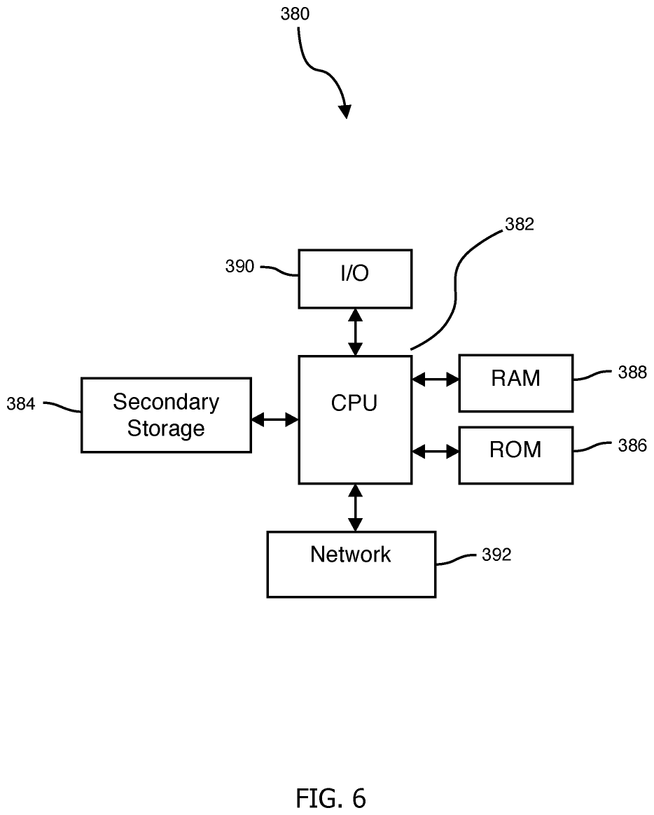

FIG. 6 illustrates a computer system 380 suitable for implementing one or more examples disclosed herein. For example, one or more components of the RAN 118 may be implemented on a computer system, such as a server, having at least some components and/or functionality of the computer system 380. Similarly, one or more components of the EdgeRIC 120 may be implemented on a computer system, such as a server, having at least some components and/or functionality of the computer system 380, which may also include one or more components of the RAN 118. Still further, in some examples, the UE 104 may be implemented on, or as, a computer system, such as a server, having at least some components and/or functionality of the computer system 380.

In an example, the computer system 380 includes a CPU 382 that is in communication with memory devices including secondary storage 384, read only memory (ROM) 386, random access memory (RAM) 388, input/output (I/O) devices 390, and network connectivity devices 392. The CPU 382 may be implemented as one or more CPU chips.

It is understood that by programming and/or loading executable instructions onto the computer system 380, at least one of the CPU 382, the RAM 388, and the ROM 386 are changed, transforming the computer system 380 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the computer system 380 is turned on or booted, the CPU 382 may execute a computer program or application. For example, the CPU 382 may execute software or firmware stored in the ROM 386 or stored in the RAM 388. In some cases, on boot and/or when the application is initiated, the CPU 382 may copy the application or portions of the application from the secondary storage 384 to the RAM 388 or to memory space within the CPU 382 itself, and the CPU 382 may then execute instructions that the application is comprised of. In some cases, the CPU 382 may copy the application or portions of the application from memory accessed via the network connectivity devices 392 or via the I/O devices 390 to the RAM 388 or to memory space within the CPU 382, and the CPU 382 may then execute instructions that the application is comprised of. During execution, an application may load instructions into the CPU 382, for example load some of the instructions of the application into a cache of the CPU 382. In some contexts, an application that is executed may be said to configure the CPU 382 to do something, e.g., to configure the CPU 382 to perform the function or functions promoted by the subject application. When the CPU 382 is configured in this way by the application, the CPU 382 becomes a specific purpose computer or a specific purpose machine.

The secondary storage 384 is typically comprised of one or more disk drives or tape drives and is used for non-volatile storage of data and as an over-flow data storage device if RAM 388 is not large enough to hold all working data. Secondary storage 384 may be used to store programs which are loaded into RAM 388 when such programs are selected for execution. The ROM 386 is used to store instructions and perhaps data which are read during program execution. ROM 386 is a non-volatile memory device which typically has a small memory capacity relative to the larger memory capacity of secondary storage 384. The RAM 388 is used to store volatile data and perhaps to store instructions. Access to both ROM 386 and RAM 388 is typically faster than to secondary storage 384. The secondary storage 384, the RAM 388, and/or the ROM 386 may be referred to in some contexts as computer readable storage media and/or non-transitory computer readable media.

I/O devices 390 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 392 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards, and/or other well-known network devices. The network connectivity devices 392 may provide wired communication links and/or wireless communication links (e.g., a first network connectivity device 392 may provide a wired communication link and a second network connectivity device 392 may provide a wireless communication link). Wired communication links may be provided in accordance with Ethernet (IEEE 802.3), Internet protocol (IP), time division multiplex (TDM), data over cable service interface specification (DOCSIS), wavelength division multiplexing (WDM), and/or the like. In an example, the radio transceiver cards may provide wireless communication links using protocols such as code division multiple access (CDMA), global system for mobile communications (GSM), long-term evolution (LTE), WiFi (IEEE 802.11), Bluetooth, Zigbee, narrowband Internet of things (NB IoT), near field communications (NFC), radio frequency identity (RFID). The radio transceiver cards may promote radio communications using 5G, 5G New Radio, or 5G LTE radio communication protocols. These network connectivity devices 392 may enable the CPU 382 to communicate with the Internet or one or more intranets. With such a network connection, it is contemplated that the CPU 382 might receive information from the network, or might output information to the network in the course of performing the above-described method steps. Such information, which is often represented as a sequence of instructions to be executed using CPU 382, may be received from and outputted to the network, for example, in the form of a computer data signal embodied in a carrier wave.

Such information, which may include data or instructions to be executed using CPU 382 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The CPU 382 executes instructions, codes, computer programs, scripts which it accesses from hard disk, floppy disk, optical disk (these various disk-based systems may all be considered secondary storage 384), flash drive, ROM 386, RAM 388, or the network connectivity devices 392. While only one CPU 382 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 384, for example, hard drives, floppy disks, optical disks, and/or other device, the ROM 386, and/or the RAM 388 may be referred to in some contexts as non-transitory instructions and/or non-transitory information.

In an example, the computer system 380 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an example, virtualization software may be employed by the computer system 380 to provide the functionality of a number of servers that is not directly bound to the number of computers in the computer system 380. For example, virtualization software may provide twenty virtual servers on four physical computers. In an example, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third party provider. Some cloud computing environments may comprise cloud computing resources owned and operated by the enterprise as well as cloud computing resources hired and/or leased from a third party provider.

In an example, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 380, at least portions of the contents of the computer program product to the secondary storage 384, to the ROM 386, to the RAM 388, and/or to other non-volatile memory and volatile memory of the computer system 380. The CPU 382 may process the executable instructions and/or data structures in part by directly accessing the computer program product, for example by reading from a CD-ROM disk inserted into a disk drive peripheral of the computer system 380. Alternatively, the CPU 382 may process the executable instructions and/or data structures by remotely accessing the computer program product, for example by downloading the executable instructions and/or data structures from a remote server through the network connectivity devices 392. The computer program product may comprise instructions that promote the loading and/or copying of data, data structures, files, and/or executable instructions to the secondary storage 384, to the ROM 386, to the RAM 388, and/or to other non-volatile memory and volatile memory of the computer system 380.

In some contexts, the secondary storage 384, the ROM 386, and the RAM 388 may be referred to as a non-transitory computer readable medium or a computer readable storage media. A dynamic RAM example of the RAM 388, likewise, may be referred to as a non-transitory computer readable medium in that while the dynamic RAM receives electrical power and is operated in accordance with its design, for example during a period of time during which the computer system 380 is turned on and operational, the dynamic RAM stores information that is written to it. Similarly, the CPU 382 may comprise an internal RAM, an internal ROM, a cache memory, and/or other internal non-transitory storage blocks, sections, or components that may be referred to in some contexts as non-transitory computer readable media or computer readable storage media.

While several examples have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various examples as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A system, comprising:
a communication network having a cloud portion and an edge portion, the communication network comprising a cloud controller, a radio access network (RAN), and an edge computing device, wherein the edge computing device is co-located with at least a portion of the RAN and is configured to, within one transmission time interval (TTI) of the RAN:
obtain network state information of the communication network;
determine control actions for modifying operational settings of the RAN; and
transmit the control actions to the RAN.

2. The system of claim 1, wherein the network state information includes wireless state information of the communication network and RAN state information of the RAN.

3. The system of claim 2, wherein the network state information includes applications state information of an application executing on a user equipment communicatively coupled to the RAN.

4. The system of claim 2, wherein the wireless state information comprises a Channel Quality Indicator (CQI) and the RAN state information comprises a value of backlogged bytes remaining in a downlink queue of the RAN.

5. The system of claim 1, wherein the edge computing device determines the control actions by applying a reinforcement learning policy to the network state information.

6. The system of claim 1, wherein the edge computing device is implemented by first compute resources of a computing device which implements at least a portion of a Distributed Unit of the RAN via second compute resources of the computing device.

7. The system of claim 1, wherein the control actions are weights which specify a quantity of resources to allocate to a plurality of user equipments communicatively coupled to the RAN.

8. The system of claim 1, wherein the control actions are identifications of modulation schemes for the RAN to communicate with respective user equipments (UEs) of a plurality of UEs communicatively coupled to the RAN.

9. The system of claim 1, wherein the TTI is less than 1 millisecond.

10. An edge computing device, configured to:
obtain, from a radio access network (RAN), network state information of a communication network;
receive a machine learning policy from a cloud computing device;
apply the machine learning policy to the network state information to determine control actions for modifying operational settings of the RAN to provide communication service to a user equipment in the communication network via the RAN; and
transmit the control actions to the RAN.

11. The edge computing device of claim 10, wherein the edge computing device co-located with a distributed unit of the RAN.

12. The edge computing device of claim 10, wherein the machine learning policy is a reinforcement learning policy trained based on an emulated environment that emulates the communication network.

13. The edge computing device of claim 10, wherein the network state information includes wireless state information of the communication network and RAN state information of the RAN.

14. The edge computing device of claim 10, wherein the edge computing device communicates with the RAN via a publish-subscribe communication scheme via an E2 application protocol (E2AP) interface.

15. The edge computing device of claim 10, wherein an elapsed time between obtaining the network state information and transmitting the control actions is less than a transmission time interval (TTI) of the RAN.

16. The edge computing device of claim 15, wherein the TTI is 1 millisecond.

17. An emulated edge computing device, configured to:
implement, in an emulated network environment configured to emulate a communication network, a machine learning policy for control of operational characteristics of an emulated radio access network (RAN);
receive network state information of the emulated network environment;
apply the machine learning policy to the network state information to determine control actions for modifying operational settings of the emulated RAN; and
transmit the control actions to the emulated RAN;
receive a reward associated with operation of the emulated RAN according to the control actions, the reward determined according to a machine learning reward function; and
train the machine learning policy according to the reward.

18. The emulated edge computing device of claim 17, further configured to transmit the machine learning policy to an edge computing device in the communication network responsive to the machine learning process reaching a threshold level of training.

19. The emulated edge computing device of claim 17, wherein the emulated RAN is instantiated based on a same codebase as a RAN existing in the communication network.

20. The emulated edge computing device of claim 17, wherein the emulated network is configured to simulate wireless communication channels of the communication network in a trace-based manner based on Channel Quality Indicators (CQIs) of the communication network.
